(19) United States
(12) Patent Application Publication
(10) Pub. No.: US 2023/0196234 A1
(43) Pub. Date: Jun. 22, 2023

(54) END-TO-END CARBON FOOTPRINT LEVERAGING PREDICTION MODELS

(71) Applicant: VOLKSWAGEN AKTIENGESELLSCHAFT, Wolfsburg (DE)

(72) Inventors: Mohak BHIMANI, Sunnyvale, CA (US); Mikhail TETELMAN, Los Gatos, CA (US); Maximilian THUM, Foster City, CA (US); Ethan BOROSON, Alameda, CA (US)

(21) Appl. No.: 17/553,633

(22) Filed: Dec. 16, 2021

(51) Int. Cl. G06Q 10/06; G06Q 50/06; B60L 53/66; B60L 58/13; G06N 20/00

(52) U.S. Cl. CPC G06Q 10/06315; G06Q 10/06311; G06Q 50/06; B60L 53/66; B60L 58/13; G06N 20/00

(57) ABSTRACT

Approaches, techniques, and mechanisms are disclosed for improving end-to-end carbon footprint of electric vehicles. It is determined that an electric vehicle is requesting battery charging by a charging station. A current state of charge for the electric vehicle is used to estimate a charging time duration for the electric vehicle to reach a target state of charge. Multiple candidate time durations are generated within an available time period between a start time and an end time by a demand and footprint optimization system, each candidate time duration in the multiple candidate time durations within the available time period being no shorter than the charging time duration used to charge the electric vehicle from the current state of charge to the target state of charge. The charging time duration for battery charging is scheduled within a specific candidate time duration that is selected from among the multiple candidate time durations.

### TECHNICAL FIELD

Embodiments relate generally to electric vehicles, and, more specifically, to improving end-to-end carbon footprint of electric vehicles leveraging prediction models.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Demands from electric vehicles (EVs) on electricity grids are growing rapidly as more and more EVs are being made by vehicle manufacturers and used by vehicle owners for daily driving needs. Artificial intelligence (AI) or machine learning (ML) techniques have been developed to achieve better fuel economy or reduce fuel consumption through optimization of limited parameters used in vehicle related operations. For example, some AI/ML techniques may be used in plug-in hybrid electric vehicles (HEVs) to autonomously learn optimal fuel/electricity splits in vehicle propulsion operations from interactions between the vehicles and traffic environments for the purpose of saving fuel.

Electricity grids may provide electricity that is originally generated from a variety of energy source types such as coal, natural gas, wind, solar, hydro, etc. Systems used to operate the grids are not connected with the EVs or systems therein. Hence, the grids may use electricity generated from different mixes of fossil fuel, renewable and green energy sources at different time points to satisfy electricity demands some of which are originated from the EVs with no or little input or feedback from the EVs or the systems therein. As a result, the electricity demands from the EVs can very well be frequently satisfied by electricity coming from fossil fuel and energy sources other than green energy sources.

### BRIEF DESCRIPTION OF THE DRAWINGS

The present disclosure is illustrated by way of example, and not by way of limitation, in the figures of the accompanying drawings and in which like reference numerals refer similar elements and in which:

FIG. 1A illustrates an example framework for optimizing carbon footprints relating to electricity vehicles;

FIG. 1B illustrates an example system for optimizing carbon footprints relating to electricity vehicles;

FIG. 2A illustrates example optimization of charging schedules;

FIG. 2B illustrates an example display page (or heat map) that visualizes emissions and electricity demands;

FIG. 3A illustrates an example daily reduction of greenhouse or carbon gas emissions from optimization of charging schedules/events;

FIG. 3B illustrates an example cumulative reduction of greenhouse or carbon gas emissions from optimization of charging schedules/events;

FIG. 4 illustrates an example process flow; and

FIG. 5 is block diagram of a computer system upon which embodiments of the disclosure may be implemented.

### DETAILED DESCRIPTION

In the following description, for the purposes of explanation, numerous specific details are set forth in order to provide a thorough understanding of the present disclosure. It will be apparent, however, that the present disclosure may be practiced without these specific details. In other instances, well-known structures and devices are shown in block diagram form in order to avoid unnecessarily obscuring the present disclosure.

Embodiments are described herein according to the following outline:

1.0. General Overview

2.0. Structural Overview
2.1. Electricity Grids
2.2. Electricity Grid Data Collector
2.3. Electricity Vehicle Data Collector
2.4. Demand and Footprint Prediction Models
2.5. Demand and Footprint Visualization
2.6. Vehicle Charging Schedule Generator

3.0. Functional Overview
3.1. Minimizing Emissions
3.2. Predicting Demands
3.3. Predicting Emissions
3.4. Prioritizing Emission Savings
3.5. Optimizing Charging Schedules
3.6. Visualizing Emissions and Demands

4.0. Example Process Flows

5.0. Implementation Mechanism—Hardware Overview

6.0. Extensions and Alternatives

### 1.0. GENERAL OVERVIEW

Techniques as described herein can be used to improve overall carbon footprints of electricity or energy consumption by electric vehicles by leveraging artificial intelligence (AI) or machine learning (ML) techniques to predict or forecast energy or electricity demands and greenhouse or carbon dioxide gas emissions associated with the demands and by using predictions or forecasts of the demands and the emissions to schedule electric vehicle charging events to satisfy the demands and influence electricity or energy consumption behaviors to minimize the emissions. As used herein, “footprint” or “carbon footprint” may refer to quantities, volumes, weights, etc., of greenhouse or carbon dioxide gas emissions as a result of electricity or energy supply or consumption. Example carbon footprints as described herein may, but are not necessarily limited to only, be associated or measured in relation to one or more of: specific electricity grid(s), specific geographic area(s)/location(s), specific vehicle manufacturer(s), specific vehicle model(s), etc. In a non-limiting example, carbon footprints may refer to greenhouse or carbon dioxide gas emissions caused by generating electricity to meet electricity demands of a fleet of electric vehicles made by one or more specific vehicle manufacturers.

The techniques as described herein can be applied in a wide range of operational scenarios to connect the systems used to operate the electricity grids with the electricity vehicles or the system therein, thereby forming a feedback loop between the electric grid systems and the electric vehicles. As a non-limiting example, these techniques can be implemented by a vehicle manufacturer (e.g., VW, Audi, Porsche, etc.) to influence demand, supply, and consumption of energy or electricity by a fleet of electric vehicles made by the vehicle manufacturer. Hence, the carbon footprint relating to the fleet of electric vehicles (e.g., hybrid electric vehicles or HEV, battery electric vehicles or BEVs, etc.) can be significantly reduced or improved.

Generally speaking, any form of energy generation may have an associated carbon footprint or emission cost. An insufficiently charged plug-in hybrid electric vehicle is likely to consume fossil fuel in vehicle operations and hence emit greenhouse or carbon dioxide gas. While an electric vehicle with sufficient electric power itself emits no or little greenhouse or carbon dioxide gas, the electric vehicle may nevertheless consume electricity originally generated from an energy source (or source type) that does cause emissions.

Under the techniques as described herein, one or more demand and emission prediction models can be implemented with AI/ML techniques. Example AI/ML techniques as described herein may include, but are not necessarily limited to only, artificial neural networks (ANN or neural nets) such as deep neural networks or DNNs. The AI/ML prediction models can be trained in a model training phase with training data that include ground truths, and then applied in a model application phase to trigger or optimize electricity charging events at specific time points or intervals when carbon intensity is relatively low with electricity generation and supply. As used herein, “carbon intensity” may refer to physical quantities, volumes, weights, etc., of greenhouse gas emission per unit of electricity supply or consumption and/or per unit (e.g., 10 minutes, 15 minutes, 20 minutes, etc.) of time. As electricity supplies at different time points or intervals may be generated or supplied from different mixes or combinations of energy or electricity source types, carbon intensities—or greenhouse or carbon dioxide gas emissions per unit of electricity supply or consumption per unit of time—at these different time points or intervals can be quite different. Additionally, optionally or alternatively, “carbon intensity” may refer to physical quantities, volumes, weights, etc., of greenhouse gas emission per unit of electricity supply or consumption and/or per unit (e.g., 10 minutes, 15 minutes, 20 minutes, etc.) of time related to a particular geographic area or location such as Santa Clara County, the entire northern California region, a collection of geographic areas or locations such as California and Germany in which a fleet of electric vehicles made by a vehicle manufacturer whether underlying electric grids are connected to the same electric power transmission networks or not, general for use cases in larger geographic locations. Hence, carbon intensity as described herein may be measured or determined at various granularity levels of geography from sections or parts of a single electric grid to multiple transnational electric grids.

The AI/ML techniques enable the demand and emission prediction models to process large-scale raw data (e.g., in real time, concurrently, etc.) collected from the electricity grids and electric vehicles. These electricity grids may be deployed in many national or transnational geographic region and used to satisfy electricity demands from numerous (e.g., millions of, etc.) electric vehicles operating in these regions. The raw data collected from the grids and vehicles may span over a relatively time duration spanning up to multiple months, multiple years or even longer.

Input features can be extracted from the collected raw data and then used by the prediction models as input to generate individual and/or overall predictions, estimations or forecasts of electricity demands and/or emissions (e.g., carbon intensities, etc.) for some or all of the electricity grids and the electric vehicles for any given time point or interval. These predictions, estimations or forecasts can be further used to generate specific, detailed optimized charging plans or schedules for the (e.g., retrospective, current, future, etc.) day/week for each of some or all of the electric vehicles to reduce emissions for various operational scenarios.

Example approaches, techniques, and mechanisms are disclosed for improving carbon footprint leveraging prediction models. According to one embodiment, it is determined that an electric vehicle is requesting battery charging by a charging station. A current state of charge for the electric vehicle is used to estimate a charging time duration for the electric vehicle to reach a target state of charge. A plurality of candidate time durations is generated within an available time period between a start time and an end time by a demand and footprint optimization system, each candidate time duration in the plurality of candidate time durations within the available time period being no shorter than the charging time duration used to charge the electric vehicle from the current state of charge to the target state of charge. The charging time duration for battery charging is scheduled within a specific candidate time duration that is selected from among the plurality of candidate time durations.

In other aspects, the disclosure encompasses computer apparatuses and computer-readable media configured to carry out the foregoing techniques.

### 2.0. STRUCTURAL OVERVIEW

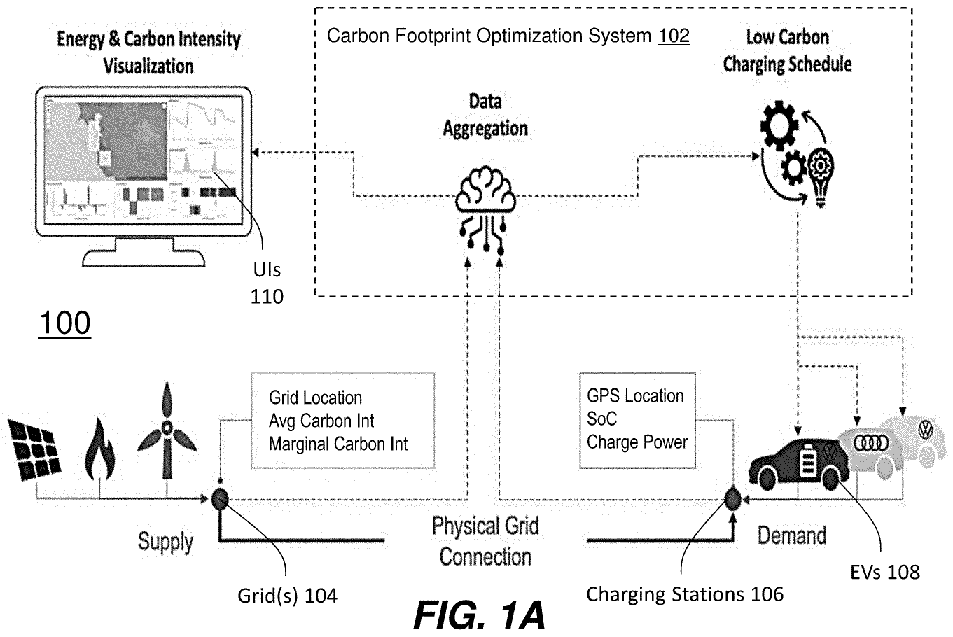

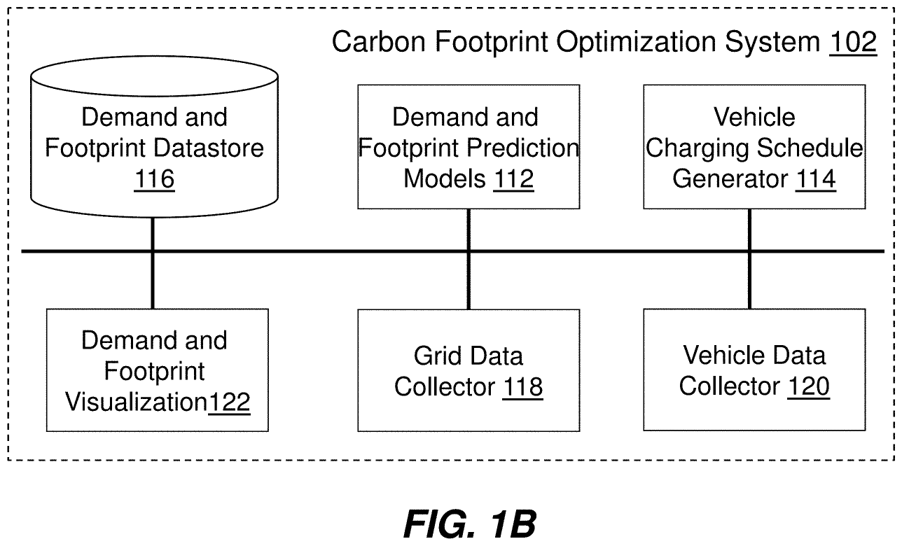

FIG. 1A illustrates an example framework 100 for optimizing carbon footprints relating to electricity vehicles (EVs). The framework (100) comprises a carbon footprint optimization system 102, one or more grid(s) 104, (e.g., home-based, etc.) charging stations 106, one or more fleets of EVs 108, one or more UIs 110 for energy and carbon intensity visualization, etc. As illustrated in FIG. 1B, in some operational scenarios, the carbon footprint optimization system (102) further comprises demand and emission prediction models 112, an electric vehicle charging schedule generator 114, an electricity demand and carbon footprint datastore 116, an electricity grid data collector 118, an electric vehicle data collector 120, an electricity demand and carbon footprint visualization block 122, etc. Each block, module, device, system, etc., illustrated in the framework (100) and/or the system (102) may be collectively or individually implemented with one or more computing devices that comprise any combination of hardware and software configured to implement the various logical components described herein. For example, the one or more computing devices may include one or more memories storing instructions for implementing the various components described herein, one or more hardware processors configured to execute the instructions stored in the one or more memories, and various data repositories in the one or more memories for storing data structures utilized and manipulated by the various components.

2.1. Electricity Grids

A main responsibility of electricity grids is to comply with needs for electricity and meet demands (e.g., within respective specified service territories, etc.) at respective geographic areas or locations in which the grids are deployed. Example geographic areas or locations may include, but are not necessarily limited to only, grid service areas/districts, villages, towns, cities, counties, states or portions therein, regions, nations, any combinations of the foregoing, etc.

A plurality of green, renewable, non-renewable and/or fossil fuel energy sources (or source types) such as coal, natural gas, wind, solar, hydro, etc., can be utilized by the grids to generate or supply electricity. As used herein, “green energy source” or “green energy source types” refer to energy sources or types whose generation/production causes no or little greenhouse or carbon dioxide gas emissions. “Renewable energy source” or “renewable energy source types” refer to energy sources or types that are naturally replenishable, for example over a reasonable time span such as yearly, every few years, etc. Examples of green and renewable energy sources or types are solar or wind. In comparison, “non-renewable energy source” or “non-renewable energy source types” refer to energy sources or types that are not naturally replenishable, for example over a reasonable time span. Examples of non-renewable energy sources or types are various fossil fuels.

Due to dynamic or time varying nature of electricity demands and supplies, it may not always be possible to meet demands with electricity supplies generated with energy from 100% green and/or renewable energy sources. Not only are there fluctuating demands, but also especially there are intermittently available renewable sources, for example due to weather and seasonal factors. Sometimes, the grids are able to produce more electricity than needed to meet demands using only green and/or renewable resources. Sometimes, fossil-fuel-based power plants—e.g., peak shaving plants or Peaker Plants—are brought online to help meet marginal or average demands when the demands or corresponding loads increase and/or when electricity supplies generated from green and/or renewable sources diminish.

Under other approaches that do not implement techniques as described herein, while being responsible for supplying energy or electricity, electricity grids generally do not have a direct influence on energy demand. As the grid side and the demand side operate largely independently of each other, there is a lost opportunity to optimize energy usage and minimize greenhouse gas emissions.

In contrast, under techniques as described herein, electricity supplies from the grid(s) (104) and electricity demands from the electric vehicles (108) can be shaped, influenced and/or controlled by the system (102) to work hand in hand to help reach or accomplish a 100% renewable energy portfolio for electricity consumption by the electric vehicles (108). The system (102) can track, predict, and influence electricity demands from the electric vehicles (108) as well as energy supplies provided by the grid(s) (104) from electricity generation and/or electricity storage. Localized energy demands and associated greenhouse gas emissions in various geographic areas or locations in which the grid(s) (104) are deployed or physically connected with the electricity charging stations (106) to supply electricity to the electric vehicles (108) can be tracked, predicted, or influenced by triggering or scheduling electric charging events at optimal or optimized times for the electric vehicles (108).

2.2. Electricity Grid Data Collector

As shown in FIG. 1B, the system (102) may comprise an electricity grid data collector 118 that interacts with (grid) system(s) used to operate or control the electricity grid(s) (104) for the purpose of collecting grid data relating to the electricity grid(s) (104). The system (102) can be operationally or communicatively linked with the grid system(s) via one or more first data communication network connections over one or more first computer networks. The first data communication network connections can be supported or implemented with any combination of a wide variety of communication techniques including but not limited to those related to cellular communications, wire-based communications, wireless communications, optical communications, ethernet communications, etc.

Example grid data as described herein may include, but are not necessarily limited to only, some or all of: grid location(s), average carbon intensities, marginal carbon intensities, etc., of the electricity grid(s) (104). Additionally, optionally or alternatively, the grid data may include other grid data types such as source types of energy supply and production at each of some or all of the grid(s) (104), available transmission capacity used to satisfy electricity demands at each of some or all of the grid(s) (104), dynamic or estimated energy demands from consumers including but not limited to those related to the electric vehicles (108) at each of some or all of the grid(s) (104), available energy storage for electricity flowing to or from the grid(s) (104) at each of some or all of the grid(s) (104), etc. In some operational scenarios, additional grid data may be derived or computed from the collected grid data, for example by the system (102) or by an attendant system/device such as an aggregation node operating in conjunction with the system (102).

The collected grid data from the electricity grid(s) (104) (and/or the additional grid data if any) may be provided by the grid data collector (118) to other blocks or modules in the system (200). Additionally, optionally or alternatively, the grid data can be stored in, and managed or accessed through, the electricity demand and carbon footprint datastore (116).

2.3. Electricity Vehicle Data Collector

As shown in FIG. 1B, the system (102) may comprise an electricity vehicle data collector 120 that interacts with system(s) (not shown) used to operate the electricity vehicle charging stations (106) and/or the electricity vehicles (108) for the purpose of collecting vehicle data relating to the electricity vehicles (108). The system (102) can be operationally or communicatively linked with the electricity vehicle charging stations (106) and/or the electricity vehicles (108) via one or more second data communication network connections over one or more second computer networks. The second data communication network connections can be supported or implemented with any combination of a wide variety of communication techniques including but not limited to those related to cellular communications, wire-based communications, wireless communications, optical communications, ethernet communications, etc.

Example vehicle data may include, but are not necessarily limited to only, some or all of: geographic positioning system (GPS) generated locations, states of charge (SoCs), (e.g., percentage charged, full, etc.) charge powers, user input from interacting with drivers or owners of the electric vehicles (108, etc., of the electric vehicles (108).

The collected vehicle data in connection with the electric vehicles (108) may be provided by the vehicle data collector (120) to other blocks or modules in the system (200). Additionally, optionally or alternatively, the vehicle data can be stored in or accessed through the electricity demand and carbon footprint datastore (116).

2.4. Demand and Footprint Prediction Models

As shown in FIG. 1B, the system (102) may comprise one or more demand and emission prediction models (112) to use the grid data and vehicle data as raw data or input for predicting demands and emissions.

To achieve minimized emissions associated with charging electric vehicles, the prediction/forecast models (112) can be trained and used to make predictions for both emissions per unit amount of energy produced at any given time and the total energy demand at the time. Greenhouse or carbon gas emission data and electric energy demands (or patterns thereof) relating to electric vehicles can be used to train or build the prediction/forecast models (112) in a model training phase. Operational parameters in the prediction/forecast models (112) such as weights or biases used with neuron activation functions of neural nets can be optimized by minimizing prediction/forecast errors of the prediction/forecast models (112). These prediction/forecast errors can be measured or determined in relation to labels or ground truths in training data base at least in part on objective functions, error functions, distance functions, penalty functions, etc., and back propagated to update the weights or biases of the neural nets.

In a model application or deployment phase, the prediction/forecast models (112) with the optimized operational parameters can extract input features of the same types used in the model training phase and use the input features as input (e.g., input neurons, etc.) to generate predictions/forecasts of electricity demands and emissions at grid and/or vehicle levels. These predictions/forecasts from the prediction/forecast models (112) can be used to setup, trigger or schedule optimized charging events—e.g., automatically under permissions of drivers or owners of the electric vehicles (108 of FIG. 1A)—to maximize charging of the electric vehicles (108 of FIG. 1A) at time points or intervals of relatively low emissions associated with electricity production or supply and to minimize charging of the electric vehicles (108 of FIG. 1A) at time points or intervals of relatively high emissions associated with electricity production or supply. Hence, the electric vehicles (108 of FIG. 1A) can be charged with energy that is as green as possible.

2.5. Demand and Footprint Visualization

The system (102) comprises a demand and footprint visualization block (122 of FIG. 1B) visually present or display raw and/or processed demand and emission data including but not limited to report and trend data on the UIs (110) to electricity grid operators and/or human drivers or owners of the electric vehicles, for the purpose of planning, forecasting and/or optimizing electricity generation or supply of the electric grids and usages and operations of the electric vehicles. As used herein, “drivers” or “owners” of the electric vehicles may refer to (e.g., human, business entity, non-business entity, etc.) customers who own, operate or use the electric vehicles, and who subscribe to electricity/utility services provided by operators of the electricity grid(s) to meet demands of the electric vehicles for electricity.

In an example, the grid data can be used as a part input to derive or generate electricity demand and/or carbon footprint display pages to be used in, or rendered on the UIs (110), by the electricity demand and carbon footprint visualization block (122). In another example, the vehicle data can be used as a part input to derive or generate electricity demand and/or carbon footprint display pages to be used in, or rendered on the UIs (110), by the electricity demand and carbon footprint visualization block (122).

2.6. Vehicle Charging Schedule Generator

As shown in FIG. 1B, the system (102) may comprise a charging schedule generator (114) to schedule, concentrate, consolidate and/or optimize charging events for some or all of the electric vehicles (108 of FIG. 1A). For example, the charging schedule generator (114) may fit or adjust charging durations for some electric vehicles within relatively large available charging time durations before these electric vehicles resume driving operations, when drivers/owners of these electric vehicles have provided permissions to the system (102) to schedule charging events. Specific portions or intervals within the available charging time may be used by the charging schedule generator (114) to meet electric energy demands such that greenhouse or carbon gas emissions associated with these charging events are minimized.

In some operational scenarios, the system (102) is a non-distributed system implemented with one or more (e.g., cloud based, remote to or outside of electric vehicles, etc.) computing devices in a single location. Additionally, optionally or alternatively, the system (102) may be a distributed system implemented with multiple (e.g., cloud based, remote or outside of electric vehicles, in electric vehicles, etc.) computing devices spanning or distributed across multiple locations. These computing devices may be connected with wireless network or data connections, wired network or data connections, a combination of wired or wireless connections, etc. Hence, the system (102) can operate in different configurations.

Algorithms or process flows implemented in the system (102) can run centrally or distributed. Some algorithms or process flows may be performed with in-vehicle devices/modules of the system (102).

In an example, multiple instances of the vehicle charging schedule generators may be respectively deployed in vehicle with the electric vehicles (108). Each instance in the multiple instances of the vehicle charging schedule generators may be used to schedule and/or optimize charging events for a corresponding electric vehicle in which the instance is deployed.

In another example, multiple in-vehicle or in-charging-station schedule client-side optimizers or agents may be respectively deployed in vehicle with the electric vehicles (108). Each client-side optimizer or agent may operate with the (remote located or cloud-based) vehicle charging schedule generator (114) to schedule and/or optimize charging events for a corresponding electric vehicle in which the client-side optimizer or agent is deployed.

### 3.0. FUNCTIONAL OVERVIEW

In an embodiment, some or all techniques and/or methods described below may be implemented using one or more computer programs, other software elements, and/or digital logic in any of a general-purpose computer or a special-purpose computer, while performing data retrieval, transformation, and storage operations that involve interacting with and transforming the physical state of memory of the computer.

3.1. Minimizing Emissions

The system (102 of FIG. 1A or FIG. 1B) can be used to solve the emission reduction problem as a relatively simple data-driven (or data-based) problem rather than as a complex modeling problem of human demands. More specifically, the system (102) may be driven, for example entirely with no or minimal user input in real time or near real time operations, by collected raw data. As a result, the system (102) can operate relatively efficiently without needing to determine or know specifically how humans may act in response to various suggestions for preventing or reducing emissions.

The system (102) closes a communication loop, or forms a bridge, between the grid(s) (104) and the electric vehicles (108). In addition to vehicle-related data collected from the electric vehicles (108) and/or the (e.g., in-home, in-office, commercial, etc.) charging stations, the system also collects grid data relating to the electric grid(s) (104). The collected grid data may include, but are not necessarily limited to only, data regarding multiple underlying systems involved in generating, producing, storing and distributing energy or electricity to the electric vehicles (104) or consumer devices other than (plug-in) electric vehicles or hybrid electric vehicles. The system (102) can leverage the bridge or the communication loop or the collected raw data to optimize carbon footprint associated with operations of the electric vehicles (108). The prediction (or forecast) models (112) built in with the system (102) can operate to use the raw data collected from the systems used to operate the grid(s) (104), the charging stations (106) and/or the electric vehicles (108) to generate estimations of demands for electricity and emissions of these demands as well as other demands (not for the electric vehicles (108)) for electricity. These predictions or estimations of electricity demands and emissions from prediction/forecast models (112) in the system (102) may include, but are not necessarily limited to only, some or all of: current day demands of the electric vehicles (108), upcoming week's forecast demands of the electric vehicles (108), past, present and future emissions associated with charging the electric vehicles (108), etc. The system (102) can use these estimations to plan or schedule relatively smart/green charging events for the electric vehicles (108) and influence charging patterns of the electric vehicles (108).

For example, in some operational scenarios, the system (102) can be used to enable a relatively large vehicle manufacture (e.g., VW, Audi, Porsche, etc.) to respond to, influence and reshape dynamic or time varying demands for electricity from a relatively large population of electric or electrified vehicles made by the manufacturer to result in an added demand flexibility for minimizing emissions. More specifically, the demand flexibility enabled with the system (102) can be exploited to minimize greenhouse gas emission or carbon footprint associated with operations of the electric vehicles such as charging and discharging (e.g., vehicle operations, reversible energy or electricity flows, giving back electricity from the electric vehicles to the connected grid, etc.) of the electric vehicles.

Most drivers charge their electric vehicles when they return home from work or schedule an overnight charge when electricity is not subject to peak pricing. While the electricity may be cheaper, producing the electricity during these hours may generate significant greenhouse or carbon gas emissions, for example in a grid that relies heavily on solar power such as in California.

Instead of charging electric vehicles that may well inadvertently induce relatively high emission costs, the system (102) as described herein can be used to provide a driver or owner of an electric vehicle with a better option to minimize carbon impacts of owning and driving the electric vehicle. For example, the system (102) can cause the electric vehicle to be charged during specific daytime hours (if possible) when utility cost for electricity is still cheap, but as the sun is up, the electricity can be generated using solar energy that prevents or reduces greenhouse or carbon gas emissions across the grid used to charge the electric vehicle.

By way of illustration but not limitation, a driver of an electric vehicle may return home from work nightly around 7 PM and leave for work the next day at 9 AM. In order to maintain the appropriate level of charge for usage throughout the day, the vehicle needs to charge for two (2) hours before the driver leaves for work in the morning. Without a charging strategy optimized by the system (102), the vehicle would be charged using relatively dirty energy, from 7-9 PM or overnight. Under techniques as described herein, the system (102) can cause the vehicle to be charged during 7-9 AM the next day instead of the evening or overnight hours. As a result, greenhouse or carbon gas emissions associated with charging the vehicle can be significantly reduced. The change of time for charging the vehicle may well reduce emissions from this charging event by 50% or more as compared with the evening or overnight hours.

The vehicle charging schedule generator (114) in the system (102) may implement a process flow or algorithm for generating optimized charging events or schedules for an electric vehicle. In some operational scenarios, the process flow or algorithm may be in part or in whole performed by an instance or portion of the vehicle charging schedule generator (114) of the system (102) implemented by one or more computing devices in an electric vehicle. Some or all of the process flow or algorithm can be performed in vehicle to set up a specific charging event with a selection of a specific optimized time or interval to charge the electric vehicle. The process flow or algorithm can access the demand and footprint prediction models (112) to determine, or generate an estimation of, expected or forecasted demand of the electric vehicle for electricity, energy or power until the next charging session or event for the electric vehicle. The process flow or algorithm can also determine the time that the electric vehicle needs to be ready to leave by, for example based at least in part on user input received from the driver or owner of the vehicle; and identify or determine a plurality of candidate or potential time blocks for charging the electric vehicle before that time. The process flow or algorithm can access the demand and footprint prediction models (112) to determine, or generate an estimation of, emissions associated with charging the electric vehicle in each of the candidate or potential time blocks and select a specific candidate or potential time block with the lowest emissions—as the specific optimized time or interval to charge the electric vehicle—from among the plurality of candidate time blocks.

This saving of emissions can be multiplied across some or all of the electric vehicles (108), which can lead to a significant reduction in greenhouse or carbon gas emissions generated by charging numerous electric vehicles worldwide.

3.2. Predicting Demands

The system (102) or the electricity demand and carbon prediction models (112) therein can be used to extract input features from raw data (or history data) collected from the grid(s) (104), the electric vehicles (108), weather information sources, etc., and use these input features to generate estimations, predictions or forecasts of current or future electricity demands at various levels such as global, regional, grid, locale and/or vehicle levels. Example input features may include, but are not necessarily limited to only, some or all of: individual and/or overall daily trends, seasonal trends, local/global factors, activities impacting driving, and/or location based weather and climate having influences on electricity or energy demands at the grid level for specific or individual local areas, cities, states, and so on. For example, daylight saving hour changes may globally affect electricity or energy demands and/or production in connection with electric vehicles or grids. Likewise, seasonal weather changes may globally affect carbon intensity as available solar energy may change from season to season. Activities or events such as games, concerts, popular outdoor activities, etc., can also influence people to go to certain areas.

While the trends or factors represented in the input features may influence or relate to the electricity demands in a complex, multi-variate, non-linear way, the prediction models (112)—e.g., deep learning neural nets, etc.—can be used to learn and capture the complex influences the trends or factors depend on—or the multi-variate, non-linear relationships between the trends/factors and the electricity demands—through optimizations of model operational parameters to minimize errors between predictions and ground truths in a model training phase and generate relatively accurate estimations, predictions or forecasts of electricity demands at a given level such as the grid level in a model deployment or application phase.

Electricity demands (from electric vehicles and/or non-electric vehicle electricity or energy consumers) as predicted by the prediction models (112) for some or all of the various levels can be used to determine, or gain an understanding of, individual and/or overall electricity demands associated with or generated by the electric vehicles (109) such as a fleet of vehicles made by one or more specific vehicle manufacturers. For example, vehicle specific or vehicle model specific electricity demand and/or electricity demand trends relating to hourly demands or demand trends, daily demands or demand trends, weekly demands or demand trends, etc., can be determined and/or predicted by the system (102) or the prediction models (112) therein.

In addition, relatively accurate information represented by these determined and/or predicted demands and demand trends can be combined with vehicle specific or vehicle model specific information battery system information to determine available charge time or durations associated with each of some or all of the electric vehicles (108) to ensure the vehicle to be charged to a corresponding or appropriate level or state of charge that satisfy specific determined or predicted electricity demands of the vehicle over various lengths of time such as next few hours, for the day, for the week, etc., until the next charging event.

For example, in some operational scenarios, the system (102) or the prediction models (112) therein can look or predict electricity demands of a customer's electric vehicle for the rest of day today and/or tomorrow. Additionally, optionally or alternatively, the system (102) or the prediction models (112) therein can look or predict electricity demands of the customer's electric vehicle beyond today or tomorrow and also look at electricity demands in a longer time window such as the next week. The system (102) may schedule a charging event for the customer's electric vehicle so that there is no need to charge the electric vehicle on Thursday as the electric vehicle may not be at its charging station at home on that day. The charging event scheduled by the system (102) may allow or add more energy/electricity/power beyond immediate needs to the electric vehicle for it to operate until the next Monday when the next charging event can be scheduled.

Additionally, optionally or alternatively, the system (102) or the prediction models (112) therein may schedule these charging events to specific times when relatively clean energy production is predicted or forecasted to be online in the next few days for the purpose of reduce individual or overall carbon footprint of electric vehicles. For example, the system (102) can incorporate weather information to determine that a relatively large amount of electricity may be produced from solar energy sources at specific times and steer or select charging schedules for electric vehicles with a relatively large charging time windows to these specific times to minimize emissions associated with charging these electric vehicles.

Hence, the optimized charging events can be generated depending on electricity supply/capacity forecasts for the electric grid(s), emissions (e.g., whether the electricity is from green energy source(s) or not, etc.) and individual available charging time window forecasts made for the electric vehicles. A forecast of an individual available charging time window for an individual electric vehicle can vary depending on how much a charging duration (e.g., during which the electric vehicle is connected to draw electricity from the grid(s) or a charging station, etc.) is needed for charging the vehicle to the maximum level or a level based on the electric vehicle's usage pattern. Dynamic vehicle information such as the state of charge (or charge capacity) of the electric vehicle as well as its forecasted demand for the rest of day today, tomorrow, within week, etc., can be collected or determined by the system (102) to estimate or predict the charging duration. The system (102) can allocate the charging duration specific times, within the available charging time window, when emissions from electricity production/supply is the lowest or relatively low as compared with other times in the available charging time.

3.3. Predicting Emissions

The system (102) or the electricity demand and carbon prediction models (112) therein can be used to extract input features from the collected raw data as well as estimations or forecasts of electricity demands predicted by the one or more demand prediction models, and use these input features to generate estimations, predictions or forecasts of current or future rate of emissions, average carbon intensities, marginal carbon intensities, etc., at various levels such as global, regional, grid, locale and/or vehicle levels. “Average carbon intensities” may refer to carbon intensities derived from averaging source type specific carbon intensities of all energy sources used to generate electricity. Additionally, optionally or alternatively, “average carbon intensities” may refer to carbon intensities derived from averaging carbon intensities incurred from generating all (provided) electricity. “Marginal carbon intensities” may refer to the rate at which carbon intensities would change by increasing or decreasing the electricity demand. Some of the input features used to generate predictions of the current or future rate of emissions, average carbon intensities, marginal carbon intensities, etc., may relate to history data of portions and/or amounts of energy or electricity from different energy source types, average carbon intensities for these energy source types, etc., used to satisfy past electricity demands. Additionally, optionally or alternatively, the input features may include past, current or future electricity demands determined or predicted at the various levels. Additionally, optionally or alternatively, the input features may include some or all of the same or similar trends having influences on electricity or energy demands, as previously discussed, at the grid level for specific or individual local areas, cities, states, and so on.

The predicted rate of emissions, average carbon intensities, marginal carbon intensities, etc., can be used by the prediction models (112) to track (e.g., in real time, in near real time, etc.), estimate or predict current or future emissions associated with electricity generation or supply by each of some or all of the grid(s) (104) to satisfy current or future electricity demands from each vehicle of some or all of the electric vehicles (108) predicted or estimated for a time duration starting from the present time (e.g., until the next charging event, until 9 am the next day, in next 6 hours, etc.). Additionally, optionally or alternatively, the predicted rate of emissions, average carbon intensities, marginal carbon intensities, etc., can be used by the prediction models (112) to track (e.g., in real time, in near real time, etc.), estimate or predict current or future savings of emissions associated with optimizing charging events to satisfy current or future electricity demands from each vehicle of some or all of the electric vehicles (108) predicted or estimated for a time duration starting from the present time (e.g., until the next charging event, until 9 am the next day, in next 6 hours, etc.).

3.4. Prioritizing Emission Savings

Once the estimations or forecasts of current or future electricity demands and emissions (e.g., rate of emission, carbon intensity, etc.) are available, the system (102) or the vehicle charging schedule generator (114) therein can rank or prioritize electric vehicles—e.g., a proper subset of vehicles presently connected to charging stations among the electric vehicles (108)— or their drivers and owners based in part or in whole on charging urgency, emission savings, a combination of charging urgency and emission savings, etc.

The system (102) or the electricity demand and carbon prediction models (112) therein can include one or more personalized prediction models for determining or predicting personalized usage patterns associated with a specific electric vehicle or a specific driver or owner thereof. The personalized prediction models can be trained—using a training data set for a population of electric vehicles or drivers/owners in a model training phase—to use input features extracted from raw training data associated with the population of electric vehicles or drivers/owners to identify or distinguish different electric vehicles or different drivers or owners in the population of electric vehicles or drivers/owners, and their respective expected charging or electricity demands and to determine or predict individual available times for charging the electric vehicle at various time points or intervals represented in the training data.

In a model application or deployment phase, the personalized prediction models can be used to extract the same type of input features from raw data collected in real time, in near real time, within a time latency such as fifteen (15) minutes, etc., from the grid(s) (104) and the electric vehicles (108) to determine or predict specific available time for charging a specific electric vehicle at the present time (e.g., immediately, shortly, within a specific time latency for device discovery or handshaking operations, etc.) after the specific electric vehicle is plugged into a (e.g., home-based, office-based, etc.) charging station. The raw data used to make individual or personalized predictions may include, but is not necessarily limited to only, data collected from the specific electric vehicle.

In response to determining—e.g., based on user input, based on estimation of the available time, etc.—that the electric vehicle is to be charged immediately as the available time for charging is relatively short or inflexible, the system may operate to cause the electric vehicle to be charged immediately.

On the other hand, in response to determining—e.g., based on user input, based on estimation of the available time, etc.—that the electric vehicle does not have to be charged immediately as the available time for charging is relatively long or flexible, the system (102) can select or identify the electric vehicle for charging event optimization. In addition, the system (102) may rank all (e.g., eligible, candidate, etc.) electric vehicles that are currently connected with charging stations and schedule flexibilities based at least in part on respective maximum emission reductions that are achievable by setting up or generating optimized charging schedules of these electric vehicles. Relatively high ranking values may be assigned to electric vehicles with relatively high maximum emission reductions achievable for the electric vehicles.

For example, a total of one million watt-hours demand for electricity for the next week or ten days may be estimated or forecasted for electric vehicles of a specific vehicle manufacturer that draw electricity from an electric grid. Customers for some of the electric vehicles may opt out and do not want the system (102) optimize charging schedules for their vehicles. Some other of the electric vehicles may need to be charged immediately. For the remaining electric vehicles, the system (102) may establish individual rankings based on their potentials for minimizing emissions. For example, electric vehicles with relatively long period of available charging time windows and/or relatively short charging durations can be given relatively high rankings so that these vehicles can be scheduled for charging when there is no or little emission. In some operational scenarios, the prediction models in the system (102) may implement constraint optimization to optimize scheduling charging events with conditions/constraints based on urgency, costs for electricity, user selections and/or options, user inputted or system-forecasted available charging time windows, etc.

3.5. Optimizing Charging Schedules

Once all the electric vehicles or their drivers/owners that do not need to be charged immediately have been ranked with their respective achievable maximum emission reductions, the system (102) or the vehicle charging schedule generator (114) therein can generate optimized charging schedules for these electric vehicles to minimize total emissions generated by charging the electric vehicles. In some operational scenarios, the optimized charging schedules may be generated for the electric vehicles in the (e.g., descending, etc.) order of their respective ranking values.

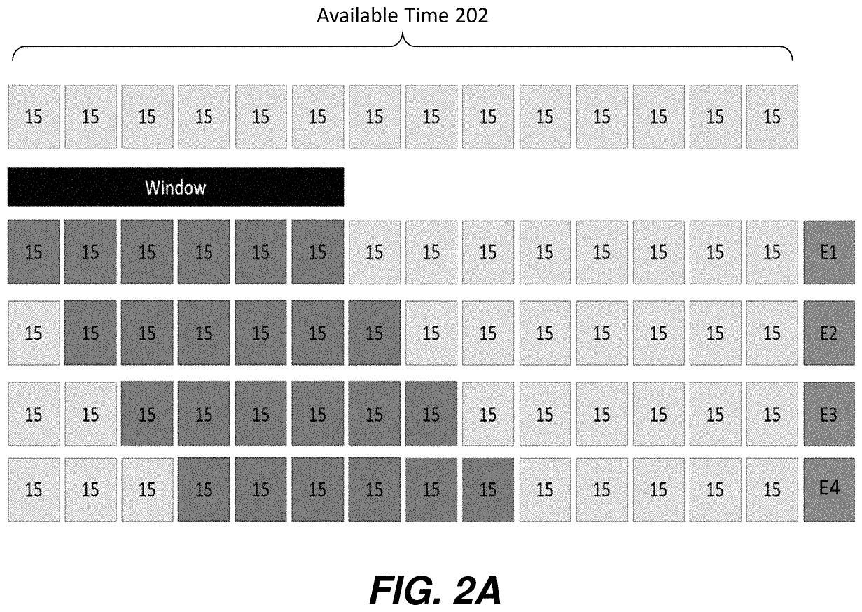

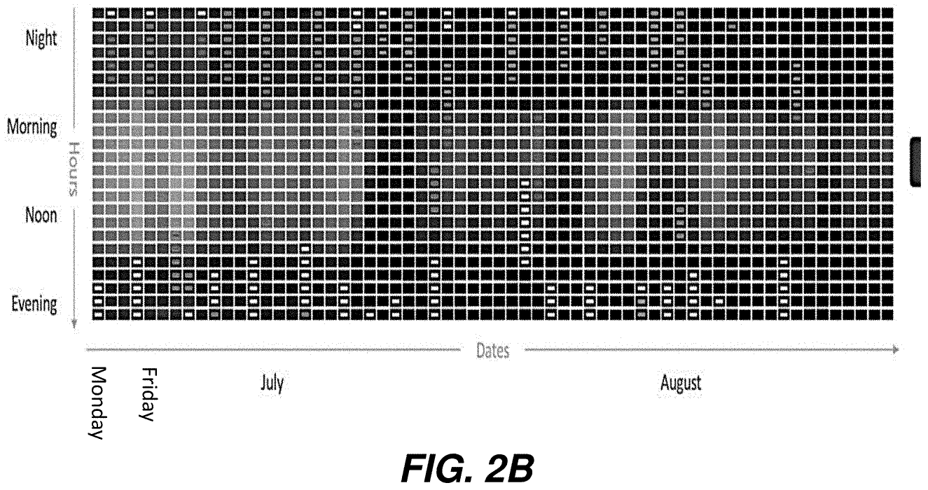

FIG. 2A illustrates example charging schedule optimization for an electric vehicle. Available time (or duration) 202 for charging the electric vehicle may be determined or estimated by the system (102). In some operational scenarios, the available time (202) may be determined based in part or in whole on user input received from the driver or owner of the electric vehicle. For example, the available time (202) may be delimited from a first time point at which the vehicle is connected to a charging station to a second time point which is specified by the user input.

In some operational scenarios, the available time (202) may be predicted or estimated based in part or in whole on predictions or estimations of personalized prediction models in the system (102) for the electric vehicle or the driver or owner of the electric vehicle. For example, the available time (202) may be predicted or estimated based at least in part on some or all of the current time (e.g., coming back from work, weekday, weekend, etc.), the current place (e.g., office location, home, etc.), and charging, discharging or driving history data of the electric vehicle.

As illustrated in FIG. 2A, the available time (202) may be partitioned into a plurality of (e.g., consecutive, etc.) time blocks such as fifteen (15) mins of time. By way of example but not limitation, the electric vehicle is, or is to be, connected to a charging station at home for 3.5 hours. The system (102) receives (e.g., from the electric vehicle, from a vehicle configuration database, from the charging station, etc.) vehicle information such as vehicle model and current state of charge of the electric vehicle and uses the vehicle information to determine that the electric car needs a charging window of just 1.5 hours of charging and hence does not need to be immediately charged. The charging window size—or 1.5 hours in the present example—may be calculated based on energy or electricity demand of the electric vehicle and the electric vehicle's availability at home, as determined or predicted by the system (102).

In response to determining that the electric vehicle does not need to be immediately charged (and that the electric vehicle currently has the highest rank value as compared with other electric vehicles) the system (102) can proceed to place or adjust the charging window of 1.5 hours within the available time (202) of 3.5 hours. This produces a plurality of candidate charging schedules denoted as “E1”, “E2”, “E3”, “E4”, and so on.

A sum of emissions (e.g., from various energy source types predicted or determined for the available time (202), etc.) for each candidate charging schedule in the plurality of candidate charging schedules within the available time (202) can be calculated for a grid—among the grid(s) (104)—to which the charging station receives electricity using the footprint prediction models in the system (102).

A specific candidate charging schedule with the lowest sum of emissions from all current determined or predicted energy source types among the plurality of candidate charging schedules within the available time (202) can be selected as the optimized charging schedule and used to charge the electric vehicle for the purpose of preventing or reducing greenhouse or carbon gas emissions.

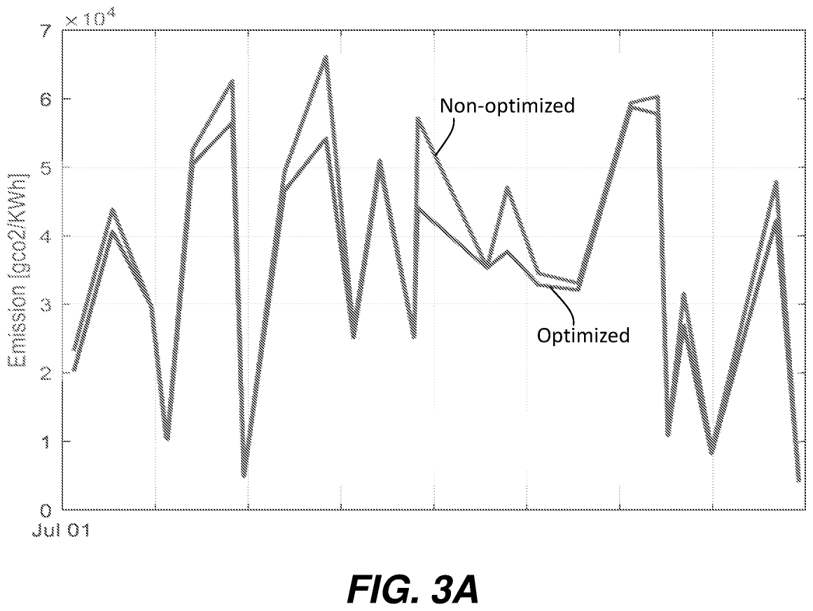

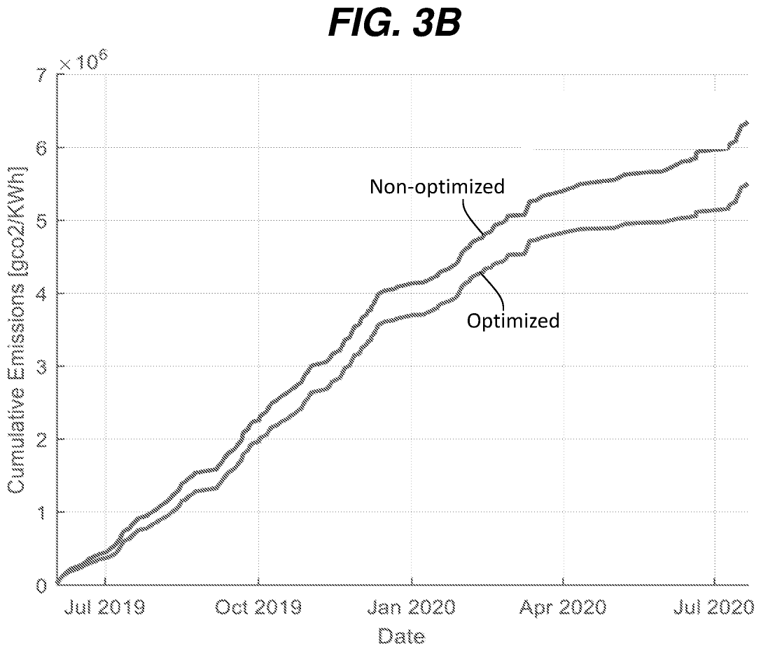

FIG. 3A illustrates an example daily reduction of greenhouse or carbon gas emissions from optimization of charging schedules/events. The horizontal axis represents time, whereas the vertical axis represents daily footprints or emissions. As compared with the normal non-optimized daily carbon footprint or emission, the optimized daily carbon footprint or emission generated with the optimized charging schedules or events can be significantly lower especially around days of peak emissions.

FIG. 3B illustrates an example cumulative reduction of greenhouse or carbon gas emissions from optimization of charging schedules/events. The horizontal axis represents time, whereas the vertical axis represents cumulative footprints or emissions which are cumulated up to date from a specific starting or reference date. As compared with the normal non-optimized cumulative carbon footprint or emission, the optimized carbon footprint or emission generated with the optimized charging schedules or events can generate or stack up more and more savings as days go by.

3.6. Visualizing Emissions and Demands

The UIs (110) in or operating in conjunction with the system (102) may be used to convey emissions and electricity demands tracked, determined, estimated, predicted and/or forecasted by the system (102) to operators of the grid(s) or drivers/owners of the electric vehicles (108). The UIs (110) may be designed with a human response model applicable to (e.g., specific, most, average, etc.) grid operators and/or drivers/owners of the electric vehicles.

FIG. 2B illustrates an example display page (or heat map) that visualizes emissions and electricity demands over every (e.g., color coded based on carbon intensity, etc.) block of one hour during a time period of two months. For example, the display page may be used to convey or report to a driver/owner of an electric vehicle as to different levels of carbon intensities—or intensities of emissions—from different mixes or combinations of energy source types in different hours representing by different color coded blocks. The display page may also be used to indicate specific blocks in which the electric vehicle has been scheduled (e.g., with optimization, without optimization, etc.) for charging during the time period represented by the specific blocks. The display page may further be used to indicate specific blocks in which the electric vehicle has not been scheduled for charging.

Likewise, display pages can be used to convey or report to operators of the grid(s) information about emissions or demands as tracked, determined, estimated, predicted and/or forecasted by the system (102).

Additionally, optionally or alternatively, trends in emissions or electricity demands can be tracked, determined, estimated, predicted and/or forecasted by the system (102) and displayed in the UIs (110) for planning purposes.

In addition to enabling charging electric vehicles with energies or energy sources that generate minimized emissions, the UIs (110) can be used to influence customer or human behaviors to change vehicle operation or usage patterns, and to use more renewable or low emission energies and energy sources as compared with other energies or energy sources given the same or comparable costs for electricity. For example, some customers can opt out and choose to charge their electric vehicles immediately or at customer-set times (e.g., 9 pm in the evening, etc.) for recharging events without being optimized. Additionally, optionally or alternatively, some customers may choose to override optimized charging schedules that have been presented to them for charging their electric vehicles. The UI(s) can be used to show gas emissions associated with optimized charging events/schedules and/or with non-optimized charging events/schedules for the same customers or among different customers of the same electricity grid.

### 4.0. EXAMPLE PROCESS FLOWS

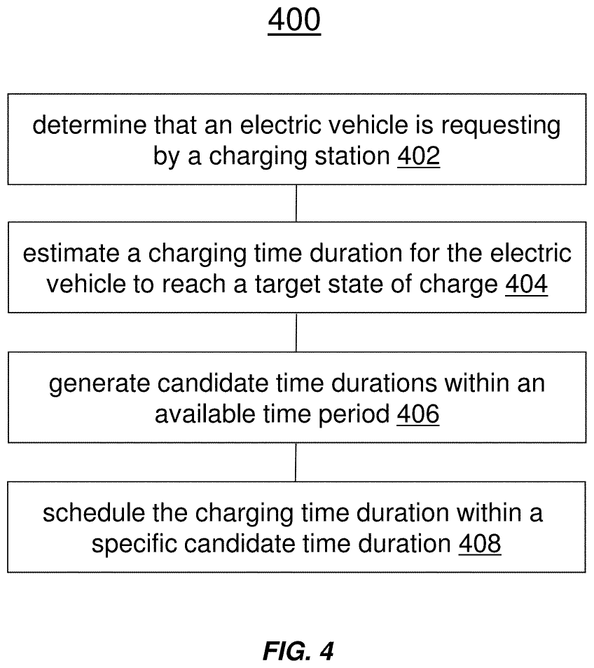

FIG. 4 illustrates an example process flow 400 according to an embodiment. In some embodiments, one or more computing devices or components may perform this process flow. In block 402, a system as described herein determines that an electric vehicle is requesting battery charging by a charging station.

In block 404, the system uses a current state of charge for the electric vehicle to estimate a charging time duration for the electric vehicle to reach a target state of charge;

In block 406, the system generates a plurality of candidate time durations within an available time period between a start time and an end time by a carbon footprint optimization system, each candidate time duration in the plurality of candidate time durations within the available time period is no shorter than the charging time duration used to charge the electric vehicle from the current state of charge to the target state of charge.

In block 408, the system schedules the charging time duration for battery charging within a specific candidate time duration that is selected from among the plurality of candidate time durations.

In an embodiment, the electric vehicle is connected with an electricity grid; a predicted greenhouse gas emission for the electricity grid to charge the electric vehicle in the specific candidate time duration is lower than all other predicted greenhouse gas emissions for the electricity grid to charge the electric vehicle in all other candidate time durations in the plurality of candidate time durations.

In an embodiment, the predicted greenhouse gas emission and the all other predicted greenhouse gas emissions are computed based on a plurality of predicted carbon intensities, in the plurality of candidate time durations respectively, for the electric grid to charge the electric vehicle; the plurality of predicted carbon intensities is generated by one or more machine learning prediction models using data collected from the electricity grid and from a plurality of electric vehicles including the electric vehicle as input data.

In an embodiment, the electric vehicle is a part of a fleet of electric vehicles; a system collects raw grid data from one or more electric grids and raw vehicle data from the fleet of electric vehicles; the system generates demand and emission forecasts relating to the one or more electric grids and the fleet of electric vehicles; the demand and emission forecasts from the system are used to select the specific candidate time duration from among the plurality of candidate time durations.

In an embodiment, the fleet of electric vehicles is made by a vehicle manufacturer; the system is operated by the vehicle manufacturer.

In an embodiment, the charging station is one of: a home-based charging station, a non-home-based charging station, etc.

In an embodiment, the electric grid uses different combinations of green energy sources, renewable energy sources or non-renewable energy sources to generate electricity at different times.

In an embodiment, a computing device is configured to perform any of the foregoing methods. In an embodiment, an apparatus comprises a processor and is configured to perform any of the foregoing methods. In an embodiment, a non-transitory computer readable storage medium, storing software instructions, which when executed by one or more processors cause performance of any of the foregoing methods.

In an embodiment, a computing device comprising one or more processors and one or more storage media storing a set of instructions which, when executed by the one or more processors, cause performance of any of the foregoing methods.

Other examples of these and other embodiments are found throughout this disclosure. Note that, although separate embodiments are discussed herein, any combination of embodiments and/or partial embodiments discussed herein may be combined to form further embodiments.

### 5.0. IMPLEMENTATION MECHANISM—HARDWARE OVERVIEW

According to one embodiment, the techniques described herein are implemented by one or more special-purpose computing devices. The special-purpose computing devices may be desktop computer systems, portable computer systems, handheld devices, smartphones, media devices, gaming consoles, networking devices, or any other device that incorporates hard-wired and/or program logic to implement the techniques. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques.

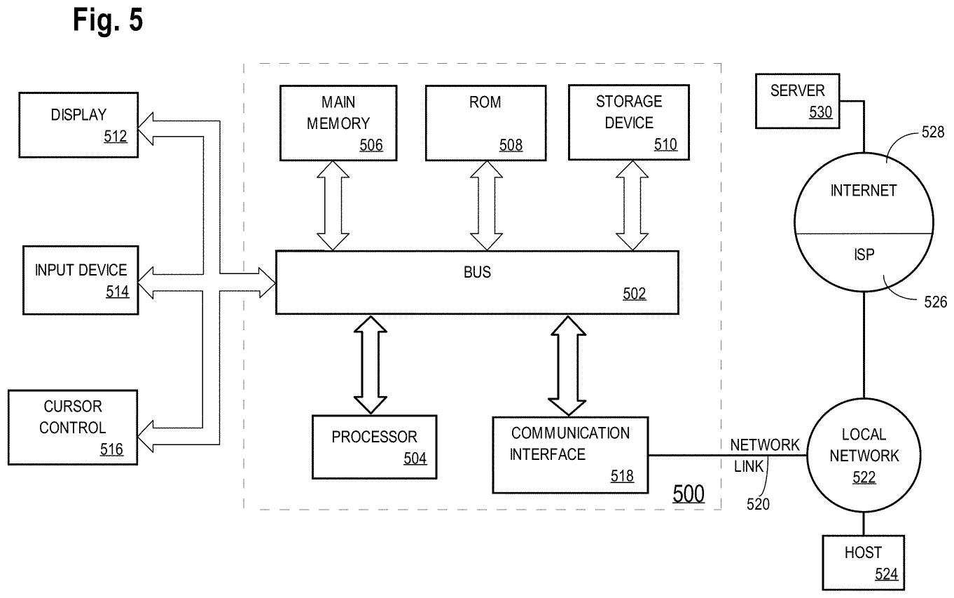

FIG. 5 is a block diagram that illustrates a computer system 500 utilized in implementing the above-described techniques, according to an embodiment. Computer system 500 may be, for example, a desktop computing device, laptop computing device, tablet, smartphone, server appliance, computing main image, multimedia device, handheld device, networking apparatus, or any other suitable device.

Computer system 500 includes one or more busses 502 or other communication mechanism for communicating information, and one or more hardware processors 504 coupled with busses 502 for processing information. Hardware processors 504 may be, for example, a general purpose microprocessor. Busses 502 may include various internal and/or external components, including, without limitation, internal processor or memory busses, a Serial ATA bus, a PCI Express bus, a Universal Serial Bus, a HyperTransport bus, an Infiniband bus, and/or any other suitable wired or wireless communication channel.

Computer system 500 also includes a main memory 506, such as a random access memory (RAM) or other dynamic or volatile storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes one or more read only memories (ROM) 508 or other static storage devices coupled to bus 502 for storing static information and instructions for processor 504. One or more storage devices 510, such as a solid-state drive (SSD), magnetic disk, optical disk, or other suitable non-volatile storage device, is provided and coupled to bus 502 for storing information and instructions.

Computer system 500 may be coupled via bus 502 to one or more displays 512 for presenting information to a computer user. For instance, computer system 500 may be connected via an High-Definition Multimedia Interface (HDMI) cable or other suitable cabling to a Liquid Crystal Display (LCD) monitor, and/or via a wireless connection such as peer-to-peer Wi-Fi Direct connection to a Light-Emitting Diode (LED) television. Other examples of suitable types of displays 512 may include, without limitation, plasma display devices, projectors, cathode ray tube (CRT) monitors, electronic paper, virtual reality headsets, braille terminal, and/or any other suitable device for outputting information to a computer user. In an embodiment, any suitable type of output device, such as, for instance, an audio speaker or printer, may be utilized instead of a display 512.

In an embodiment, output to display 512 may be accelerated by one or more graphics processing unit (GPUs) in computer system 500. A GPU may be, for example, a highly parallelized, multi-core floating point processing unit highly optimized to perform computing operations related to the display of graphics data, 3D data, and/or multimedia. In addition to computing image and/or video data directly for output to display 512, a GPU may also be used to render imagery or other video data off-screen, and read that data back into a program for off-screen image processing with very high performance. Various other computing tasks may be off-loaded from the processor 504 to the GPU.

One or more input devices 514 are coupled to bus 502 for communicating information and command selections to processor 504. One example of an input device 514 is a keyboard, including alphanumeric and other keys. Another type of user input device 514 is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane. Yet other examples of suitable input devices 514 include a touch-screen panel affixed to a display 512, cameras, microphones, accelerometers, motion detectors, and/or other sensors. In an embodiment, a network-based input device 514 may be utilized. In such an embodiment, user input and/or other information or commands may be relayed via routers and/or switches on a Local Area Network (LAN) or other suitable shared network, or via a peer-to-peer network, from the input device 514 to a network link 520 on the computer system 500.

A computer system 500 may implement techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and use a modem to send the instructions over a network, such as a cable network or cellular network, as modulated signals. A modem local to computer system 500 can receive the data on the network and demodulate the signal to decode the transmitted instructions. Appropriate circuitry can then place the data on bus 502. Bus 502 carries the data to main memory 505, from which processor 504 retrieves and executes the instructions. The instructions received by main memory 506 may optionally be stored on storage device 510 either before or after execution by processor 504.

A computer system 500 may also include, in an embodiment, one or more communication interfaces 518 coupled to bus 502. A communication interface 518 provides a data communication coupling, typically two-way, to a network link 520 that is connected to a local network 522. For example, a communication interface 518 may be an integrated services digital network (ISDN) card, cable modem, satellite modem, or a modem to provide a data communication connection to a corresponding type of telephone line. As another example, the one or more communication interfaces 518 may include a local area network (LAN) card to provide a data communication connection to a compatible LAN. As yet another example, the one or more communication interfaces 518 may include a wireless network interface controller, such as a 802.11-based controller, Bluetooth controller, Long Term Evolution (LTE) modem, and/or other types of wireless interfaces. In any such implementation, communication interface 518 sends and receives electrical, electromagnetic, or optical signals that carry digital data streams representing various types of information.

Network link 520 typically provides data communication through one or more networks to other data devices. For example, network link 520 may provide a connection through local network 522 to a host computer 524 or to data equipment operated by a Service Provider 526. Service Provider 526, which may for example be an Internet Service Provider (ISP), in turn provides data communication services through a wide area network, such as the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

In an embodiment, computer system 500 can send messages and receive data, including program code and/or other types of instructions, through the network(s), network link 520, and communication interface 518. In the Internet example, a server 530 might transmit a requested code for an application program through Internet 528, ISP 526, local network 522 and communication interface 518. The received code may be executed by processor 504 as it is received, and/or stored in storage device 510, or other non-volatile storage for later execution. As another example, information received via a network link 520 may be interpreted and/or processed by a software component of the computer system 500, such as a web browser, application, or server, which in turn issues instructions based thereon to a processor 504, possibly via an operating system and/or other intermediate layers of software components.

In an embodiment, some or all of the systems described herein may be or comprise server computer systems, including one or more computer systems 500 that collectively implement various components of the system as a set of server-side processes. The server computer systems may include web server, application server, database server, and/or other conventional server components that certain above-described components utilize to provide the described functionality. The server computer systems may receive network-based communications comprising input data from any of a variety of sources, including without limitation user-operated client computing devices such as desktop computers, tablets, or smartphones, remote sensing devices, and/or other server computer systems.

In an embodiment, certain server components may be implemented in full or in part using “cloud”-based components that are coupled to the systems by one or more networks, such as the Internet. The cloud-based components may expose interfaces by which they provide processing, storage, software, and/or other resources to other components of the systems. In an embodiment, the cloud-based components may be implemented by third-party entities, on behalf of another entity for whom the components are deployed. In other embodiments, however, the described systems may be implemented entirely by computer systems owned and operated by a single entity.

In an embodiment, an apparatus comprises a processor and is configured to perform any of the foregoing methods. In an embodiment, a non-transitory computer readable storage medium, storing software instructions, which when executed by one or more processors cause performance of any of the foregoing methods.

### 6.0. EXTENSIONS AND ALTERNATIVES

As used herein, the terms “first,” “second,” “certain,” and “particular” are used as naming conventions to distinguish queries, plans, representations, steps, objects, devices, or other items from each other, so that these items may be referenced after they have been introduced. Unless otherwise specified herein, the use of these terms does not imply an ordering, timing, or any other characteristic of the referenced items.

In the drawings, the various components are depicted as being communicatively coupled to various other components by arrows. These arrows illustrate only certain examples of information flows between the components. Neither the direction of the arrows nor the lack of arrow lines between certain components should be interpreted as indicating the existence or absence of communication between the certain components themselves. Indeed, each component may feature a suitable communication interface by which the component may become communicatively coupled to other components as needed to accomplish any of the functions described herein.

In the foregoing specification, embodiments of the disclosure have been described with reference to numerous specific details that may vary from implementation to implementation. Thus, the sole and exclusive indicator of what is the disclosure, and is intended by the applicants to be the disclosure, is the set of claims that issue from this application, in the specific form in which such claims issue, including any subsequent correction. In this regard, although specific claim dependencies are set out in the claims of this application, it is to be noted that the features of the dependent claims of this application may be combined as appropriate with the features of other dependent claims and with the features of the independent claims of this application, and not merely according to the specific dependencies recited in the set of claims. Moreover, although separate embodiments are discussed herein, any combination of embodiments and/or partial embodiments discussed herein may be combined to form further embodiments.

Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method comprising:
determining that an electric vehicle is requesting battery charging by a charging station;
using a current state of charge for the electric vehicle to estimate a charging time duration for the electric vehicle to reach a target state of charge;
generating a plurality of candidate time durations within an available time period between a start time and an end time by a carbon footprint optimization system, each candidate time duration in the plurality of candidate time durations within the available time period being no shorter than the charging time duration used to charge the electric vehicle from the current state of charge to the target state of charge;
scheduling the charging time duration for battery charging within a specific candidate time duration that is selected from among the plurality of candidate time durations.

2. The method of claim 1, wherein the electric vehicle is connected with an electricity grid; wherein a predicted greenhouse gas emission for the electricity grid to charge the electric vehicle in the specific candidate time duration is lower than all other predicted greenhouse gas emissions for the electricity grid to charge the electric vehicle in all other candidate time durations in the plurality of candidate time durations.

3. The method of claim 2, wherein the predicted greenhouse gas emission and the all other predicted greenhouse gas emissions are computed based on a plurality of predicted carbon intensities, in the plurality of candidate time durations respectively, for the electric grid to charge the electric vehicle; wherein the plurality of predicted carbon intensities is generated by one or more machine learning prediction models using data collected from the electricity grid and from a plurality of electric vehicles including the electric vehicle as input data.

4. The method of claim 1, wherein the electric vehicle is a part of a fleet of electric vehicles; wherein a system collects raw grid data from one or more electric grids and raw vehicle data from the fleet of electric vehicles; wherein the system generates demand and emission forecasts relating to the one or more electric grids and the fleet of electric vehicles; wherein the demand and emission forecasts from the system are used to select the specific candidate time duration from among the plurality of candidate time durations.

5. The method of claim 4, wherein the fleet of electric vehicles is made by a vehicle manufacturer; wherein the system is operated by the vehicle manufacturer.

6. The method of claim 1, wherein the charging station is one of: a home-based charging station, or a non-home-based charging station.

7. The method of claim 1, wherein the electric grid uses different combinations of green energy sources, renewable energy sources or non-renewable energy sources to generate electricity at different times.

8. The method of claim 1, wherein the carbon footprint optimization system includes some or all of: a grid data collector that collects grid-related data relating to one or more electricity grids; a vehicle data collector that collects vehicle-related data relating to a population of electric vehicles; one or more demand and footprint prediction models that use the collected grid-related data and the vehicle-related data to forecast demands for electricity to be provided by the one or more electricity grids and emissions for generating the electricity by the one or more electricity grids; a vehicle charging schedule generator that generates optimized charging events for some or all electric vehicles in the population of electric vehicles; a demand and footprint visualization that generates user interfaces to display demand and emission information in connection with at least one electric vehicle in the population of vehicles; a demand and footprint datastore that stores the demand and emission information.

9. One or more non-transitory computer readable media storing a program of instructions that is executable by one or more computing processors to perform:
determining that an electric vehicle is requesting battery charging by a charging station;
using a current state of charge for the electric vehicle to estimate a charging time duration for the electric vehicle to reach a target state of charge;
generating a plurality of candidate time durations within an available time period between a start time and an end time by a carbon footprint optimization system, each candidate time duration in the plurality of candidate time durations within the available time period being no shorter than the charging time duration used to charge the electric vehicle from the current state of charge to the target state of charge;
scheduling the charging time duration for battery charging within a specific candidate time duration that is selected from among the plurality of candidate time durations.

10. The media of claim 9, wherein the electric vehicle is connected with an electricity grid; wherein a predicted greenhouse gas emission for the electricity grid to charge the electric vehicle in the specific candidate time duration is lower than all other predicted greenhouse gas emissions for the electricity grid to charge the electric vehicle in all other candidate time durations in the plurality of candidate time durations.

11. The media of claim 10, wherein the predicted greenhouse gas emission and the all other predicted greenhouse gas emissions are computed based on a plurality of predicted carbon intensities, in the plurality of candidate time durations respectively, for the electric grid to charge the electric vehicle; wherein the plurality of predicted carbon intensities is generated by one or more machine learning prediction models using data collected from the electricity grid and from a plurality of electric vehicles including the electric vehicle as input data.

12. The media of claim 9, wherein the electric vehicle is a part of a fleet of electric vehicles; wherein a system collects raw grid data from one or more electric grids and raw vehicle data from the fleet of electric vehicles; wherein the system generates demand and emission forecasts relating to the one or more electric grids and the fleet of electric vehicles; wherein the demand and emission forecasts from the system are used to select the specific candidate time duration from among the plurality of candidate time durations.

13. The media of claim 12, wherein the fleet of electric vehicles is made by a vehicle manufacturer; wherein the system is operated by the vehicle manufacturer.

14. The media of claim 9, wherein the charging station is one of: a home-based charging station, or a non-home-based charging station.

15. The media of claim 9, wherein the electric grid uses different combinations of green energy sources, renewable energy sources or non-renewable energy sources to generate electricity at different times.

16. The media of claim 9, wherein the carbon footprint optimization system includes some or all of: a grid data collector that collects grid-related data relating to one or more electricity grids; a vehicle data collector that collects vehicle-related data relating to a population of electric vehicles; one or more demand and footprint prediction models that use the collected grid-related data and the vehicle-related data to forecast demands for electricity to be provided by the one or more electricity grids and emissions for generating the electricity by the one or more electricity grids; a vehicle charging schedule generator that generates optimized charging events for some or all electric vehicles in the population of electric vehicles; a demand and footprint visualization that generates user interfaces to display demand and emission information in connection with at least one electric vehicle in the population of vehicles; a demand and footprint datastore that stores the demand and emission information.

17. A system, comprising: one or more computing processors; one or more non-transitory computer readable media storing a program of instructions that is executable by the one or more computing processors to perform:
determining that an electric vehicle is requesting battery charging by a charging station;
using a current state of charge for the electric vehicle to estimate a charging time duration for the electric vehicle to reach a target state of charge;
generating a plurality of candidate time durations within an available time period between a start time and an end time by a carbon footprint optimization system, each candidate time duration in the plurality of candidate time durations within the available time period being no shorter than the charging time duration used to charge the electric vehicle from the current state of charge to the target state of charge;
scheduling the charging time duration for battery charging within a specific candidate time duration that is selected from among the plurality of candidate time durations.

18. The system of claim 17, wherein the electric vehicle is connected with an electricity grid; wherein a predicted greenhouse gas emission for the electricity grid to charge the electric vehicle in the specific candidate time duration is lower than all other predicted greenhouse gas emissions for the electricity grid to charge the electric vehicle in all other candidate time durations in the plurality of candidate time durations.

19. The system of claim 18, wherein the predicted greenhouse gas emission and all the other predicted greenhouse gas emissions are computed based on a plurality of predicted carbon intensities, in the plurality of candidate time durations respectively, for the electric grid to charge the electric vehicle; wherein the plurality of predicted carbon intensities is generated by one or more machine learning prediction models using data collected from the electricity grid and from a plurality of electric vehicles including the electric vehicle as input data.

20. The system of claim 17, wherein the electric vehicle is a part of a fleet of electric vehicles; wherein a system collects raw grid data from one or more electric grids and raw vehicle data from the fleet of electric vehicles; wherein the system generates demand and emission forecasts relating to the one or more electric grids and the fleet of electric vehicles; wherein the demand and emission forecasts from the system are used to select the specific candidate time duration from among the plurality of candidate time durations.

21. The system of claim 20, wherein the fleet of electric vehicles is made by a vehicle manufacturer; wherein the system is operated by the vehicle manufacturer.

22. The system of claim 17, wherein the charging station is one of: a home-based charging station, or a non-home-based charging station.

23. The system of claim 17, wherein the electric grid uses different combinations of green energy sources, renewable energy sources or non-renewable energy sources to generate electricity at different times.

24. The system of claim 17, wherein the carbon footprint optimization system includes some or all of: a grid data collector that collects grid-related data relating to one or more electricity grids; a vehicle data collector that collects vehicle-related data relating to a population of electric vehicles; one or more demand and footprint prediction models that use the collected grid-related data and the vehicle-related data to forecast demands for electricity to be provided by the one or more electricity grids and emissions for generating the electricity by the one or more electricity grids; a vehicle charging schedule generator that generates optimized charging events for some or all electric vehicles in the population of electric vehicles; a demand and footprint visualization that generates user interfaces to display demand and emission information in connection with at least one electric vehicle in the population of vehicles; a demand and footprint datastore that stores the demand and emission information.
